(19) United States
(12) Patent Application Publication
(10) Pub. No.: US 2016/0034128 A1
(43) Pub. Date: Feb. 4, 2016

(54) DISPLAY APPARATUS, AND DISPLAY CONTROL METHOD

(71) Applicant: Panasonic Intellectual Property Management Co., Ltd., Osaka (JP)

(72) Inventors: Tomoo KIMURA, Fukuoka (JP); Kiyoshi NAKANISHI, Osaka (JP); Shinya KUSUHARA, Nara (JP)

(21) Appl. No.: 14/818,146

(22) Filed: Aug. 4, 2015

(30) Foreign Application Priority Data
Aug. 4, 2014 (JP) 2014-158848

(51) Int. Cl. G06F 3/0486; G06F 3/0488; G06F 3/041

(52) U.S. Cl. CPC G06F 3/0486; G06F 3/0416; G06F 3/04883

(57) ABSTRACT

The display apparatus having a touch-panel includes: a display screen capable of displaying information in accordance with the touch-operation, a first display region, a second display region, and a display controller. The first display region is displayed on the display screen, and displays the information in accordance with touch-information acquired by an OS. The second display region is displayed on the display screen along with the first display region, and displays the information in accordance with the touch-information acquired by a predetermined application without via the OS. The display controller performs a display of the first display region and a display of the second display region, on the display screen in accordance with the touch-operation. The display controller moves the first display region in accordance with the touch-information acquired by the OS when the first display region on the display screen is moved by dragging over the second display region.

### BACKGROUND

1. Field of the Disclosure

The present disclosure relates to display apparatuses each equipped with a touch panel, and methods of controlling displays of the apparatuses.

2. Background Art

Among display apparatuses each equipped with a touch panel, an apparatus has been known with which a user can input characters, graphics, and the like on the touch panel though use of a pointing device (e.g. an electronic pen, mouse, or the like), and can select icons and windows displayed on a display screen thereof, via a touch operation by hand.

With the display apparatus equipped with such a touch panel, if a user touches a user's hand to the surface of the touch panel while operating the pointing device on the touch panel, such a touch by the hand will cause the touch panel to be erroneously operated. To avoid such misoperation, Japanese Patent Unexamined Publication No. 2013-109529 (Patent Literature 1) discloses a technology, so called palm rejection, with which the touch operation by hand is not detected while the touch operation using the pointing device is being performed.

### SUMMARY

The increase in diversity and convenience of operations of a touch panel has greatly boosted a demand for performing a touch operation by hand concurrently using a pointing device.

The present disclosure provides a display apparatus equipped with a touch panel, which offers an improved operability of a plurality of touch operations when they are concurrently performed.

In accordance with an aspect of the present disclosure, the display apparatus equipped with the touch panel includes: a display screen capable of displaying information in accordance with the touch operation, a first display region, a second display region, and a display controller. The first display region is displayed on the display screen, and displays the information in accordance with touch information acquired by an operating system (OS). The second display region is displayed on the display screen along with the first display region, and displays the information in accordance with the touch information acquired by a predetermined application without via the OS. The display controller performs a display of the first display region and a display of the second display region, on the display screen in accordance with the touch operation. Moreover, when the first display region on the display screen is moved by dragging over the second display region, the display controller moves the first display region in accordance with the touch information acquired by the OS.

In accordance with another aspect of the present disclosure, the display apparatus equipped with the touch panel includes: a display screen capable of displaying the information in accordance with the touch operation; a touch-information acquisition unit for acquiring the touch information on the display screen; a first display region displayed on the display screen; a second display region displayed on the display screen along with the first display region; a region determination unit for determining whether a touch position is in the first display region or the second display region based on the touch information; a first display region controller for performing a display of the first display region in accordance with the touch information notified from the region determination unit to an operating system (OS); and a second display region controller for performing a display of the second display region in accordance with the touch information notified from the region determination unit to a predetermined application without via the OS. When the touch-information acquisition unit consecutively acquires the touch information, and yet when an initial touch position is in the first display region, even if, among the consecutively-acquired touch information, at least one of the touch positions following the initial touch position is in the second display region, the first display region controller performs the display on the second display region.

In accordance with further another aspect of the present disclosure, a method of controlling a display on a display panel capable of displaying information in accordance with a touch operation, includes the steps of displaying a first display region on a display screen of the display panel, with the first display region being capable of displaying the information in accordance with touch information acquired by an OS; displaying a second display region on the display screen along with the first display region, with the second display region being capable of displaying the information in accordance with the touch information acquired by a predetermined application without via the OS; and moving the first display region in accordance with the touch information acquired by the OS when the first display region on the display screen is moved by dragging over the second display region.

The display apparatus equipped with the touch panel according to the present disclosure is effective at increasing the operability when a plurality of the touch operations is performed.

### BRIEF DESCRIPTION OF DRAWINGS

FIG. 1 is an external view of a display apparatus according to a first embodiment;

FIG. 2 is a cross-sectional view of a display panel according to the first embodiment;

FIG. 3 is a schematic configuration view of the display apparatus according to the first embodiment;

FIG. 4 is a control block diagram of the display apparatus according to the first embodiment;

FIG. 5A is a flowchart showing a control process that is performed by the display apparatus according to the first embodiment;

FIG. 5B is a flowchart showing the control process that is performed by the display apparatus according to the first embodiment;

FIG. 6A is a view showing region holding information that is formed by the display apparatus according to the first embodiment;

FIG. 6B is a view showing region holding information that is formed by the display apparatus according to the first embodiment;

FIG. 7A is a view illustrating display regions that are output from the display apparatus according to the first embodiment;

FIG. 7B is a view illustrating display regions that are output from the display apparatus according to the first embodiment;

FIG. 8 is a view illustrating an output process that is performed by a display apparatus according to a second embodiment;

FIG. 9 is a view illustrating an output process that is performed by a display apparatus according to a third embodiment;

FIG. 10 is a view illustrating an output process that is performed by a display apparatus according to a modified example of the third embodiment;

FIG. 11A is a view illustrating a function of palm rejection;

FIG. 11B is a view illustrating the function of the palm rejection;

FIG. 12 is a view illustrating a basic function of the display apparatus according to the present disclosure;

FIG. 13 is a schematic view of a system to perform the basic function of the display apparatus according to the present disclosure;

FIG. 14 is a view illustrating the basic function of the display apparatus according to the present disclosure;

FIG. 15A is a view of an example of a display result;

FIG. 15B is a view of an example of a display result; and

FIG. 16 is a view of an example of a display result.

### DETAILED DESCRIPTION

Hereinafter, embodiments will be described in detail with reference to the accompanying drawings. It is noted, however, that descriptions in more detail than necessary will sometimes be omitted. For example, detailed descriptions of well-known items and duplicate descriptions of substantially the same configuration will sometimes be omitted, for the sake of brevity and easy understanding by those skilled in the art.

Note that the accompanying drawings and the following descriptions are presented to facilitate fully understanding of the present disclosure by those skilled in the art, and are not intended to impose any limitations on the subject matter described in the appended claims.

### Basic Function

First, basic functions of a display apparatus according to the embodiments will be described, as fundamentals of the apparatus.

### (Function of Palm Rejection)

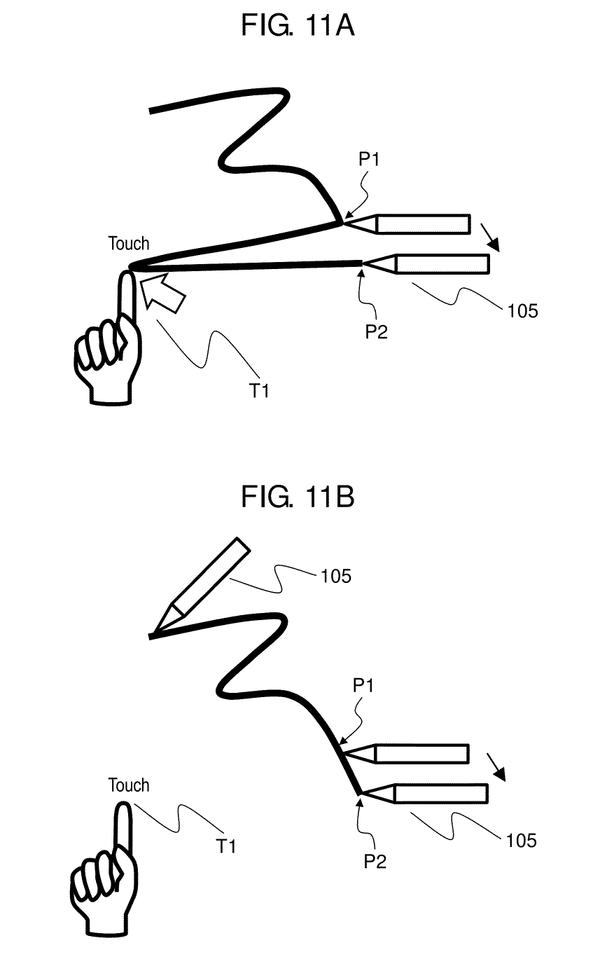

FIGS. 11A and 11B are views illustrating a function of palm rejection. FIG. 11A is the view of an example of a display performed by an application having the function of palm rejection. FIG. 11B is the view of an example of a display performed by an application according to the embodiments.

In the example of the display shown in FIG. 11A, when a user performs touch T1 on a display screen by a hand while running electronic pen 105 on the display screen by the other hand, a cursor moves in response to touch T1. This movement of the cursor causes the line being drawn by electronic pen 105 to move in a track between position P1 and position P2, resulting in the unintended drawing.

On the other hand, in the example of the display in FIG. 11B, the function of palm rejection is performed by the application according to the embodiments. In this case, as shown in FIG. 11B, the application cancels such an effect of touch T1. This allows the user to perform the touch operation by a hand while drawing graphics by the other hand using electric pen 105.

### (Function of Multi-Window)

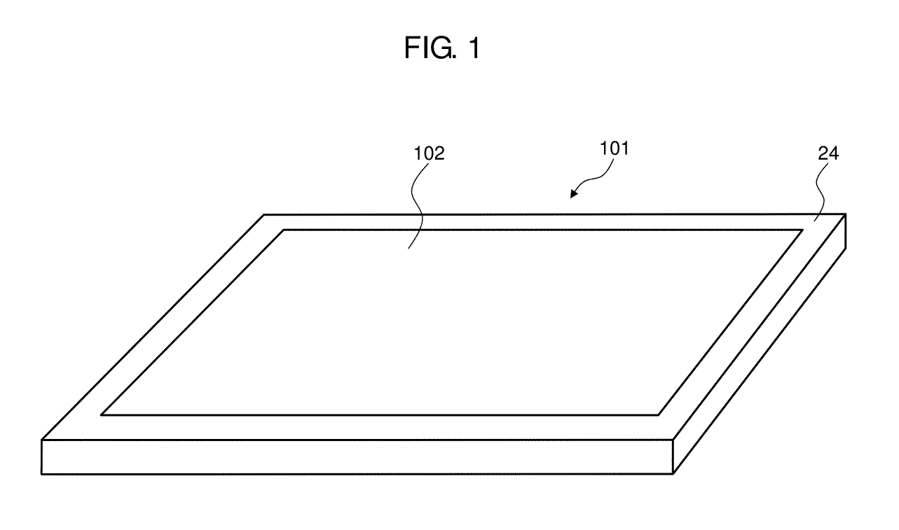

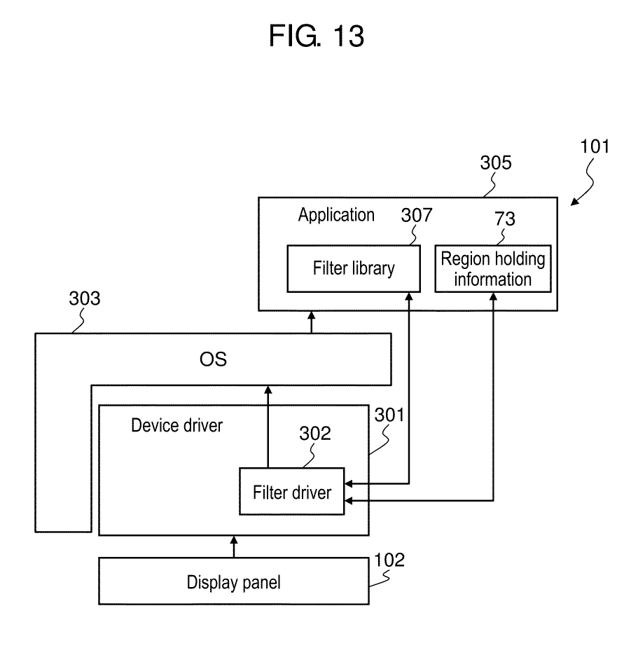

Application 305 (FIG. 13) performed by display apparatus 101 (FIGS. 1 to 3) according to the present disclosure, allows the touch operation by a hand while creating a drawing by using a pointing device such as the electric pen, in order to depict precise graphics such as a design drawing by a hand.

Display apparatus 101 displays a notification region and an exclusion region in a multi-window display. The notification region is a display region which is controlled by the application to performing the function of palm rejection. The exclusion region is a region other than the notification region, and is a region which is subjected to display-control by operating system (OS) 303.

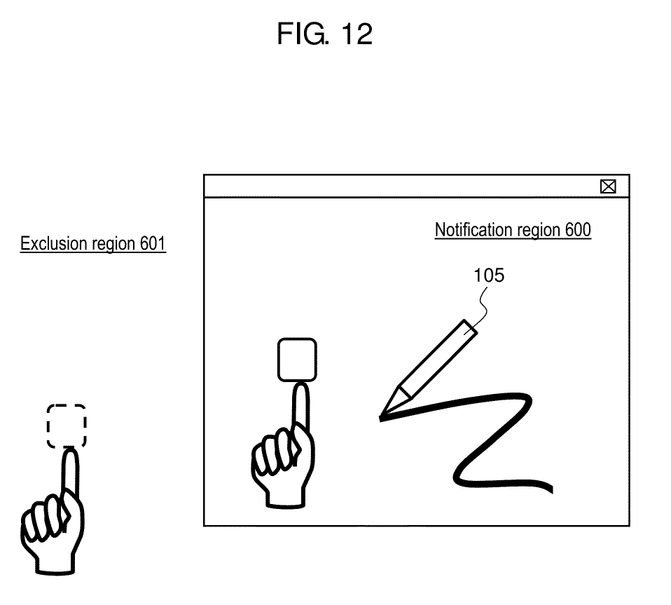

FIG. 12 is a view illustrating a basic function of display apparatus 101 according to the present disclosure. FIG. 12 shows a region (window) displayed on display panel 102 of display apparatus 101 (FIGS. 1 to 3). As described later, exclusion region 601 is a region which is subjected to display-control in accordance with touch information that OS 303 (FIG. 13) acquires. Notification region 600 is a region which is subjected to display-control in accordance with touch information that application 305 directly acquires without via OS 303.

Note that the touch information includes both positional information (such as coordinate information) of the touch on the display screen and region information to be described later.

As shown in FIG. 12, while causing electric pen 105 held by one user's hand to run in notification region 600 on the display screen so as to depict a drawing, even if the user touches the other hand to exclusion region 601, the display screen has no reaction to the touch. This is because the touch information in the exclusion region 601 is not notified directly to the application. In contrast, when the user touches the other hand to notification region 600, the touch information is notified directly to the application. Accordingly, This allows the application to independently provide various operations in addition to the operation of the function of palm rejection. For example, it is possible that the user performs a touch operation by the other hand while depicting the drawing with the one hand by using electric pen 105, thereby performing such as a pitch operation for scaling and a rotation operation of the display image. Moreover, the user is also allowed to open a menu display at the position of the touch.

As described above, display apparatus 101 according to the present disclosure is capable of displaying the two regions simultaneously on the one display screen. The two are exclusion region 601 (an example of a first display region) that is controlled in accordance with the touch information notified via OS 303 and notification region 600 (an example of a second display region) that is controlled in accordance with the touch information notified to a predetermined application without via OS 303. Hereinafter, the configuration of a system to implement this function will be described.

### (System Configuration)

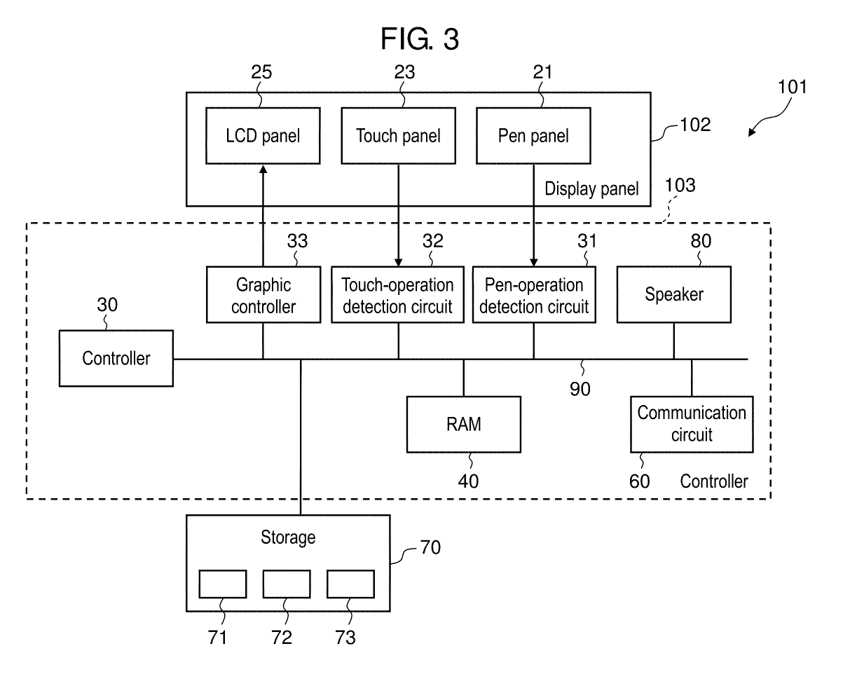

FIG. 13 is a schematic view of the system to perform the basic function of the display apparatus according to the present disclosure. FIG. 13 shows a hierarchical structure of the system that is configured with software and hardware of display apparatus 101. Display apparatus 101 is such that both device driver 301 and application 305 operate on OS 303, thereby controlling the window display on display panel 102. These operations are implemented in such a manner that controller 30 (FIG. 3), to be described later, of display apparatus 101 executes programs of both OS 303 and application 305.

Device driver 301 includes filter driver 302. Filter driver 302 notifies, to either OS 303 or application 305, the touch information detected on display panel 102 via a detection circuit.

Filter library 307 operates in application 305. Filter library 307 sets both a notification region and an exclusion region in filter driver 302, where the notification region is a region in which the touch information is notified directly to application 305, and the exclusion region is a region in which the touch information is notified to OS 303 (that is, the touch information is not notified directly to the application. In other words, in the exclusion region, notification to the application is excluded). When determining that the touch information is made in the region (notification region) where the information is to be notified directly to application 305, filter driver 302 notifies the touch information to filter library 307. On the other hand, when the touch information is made in the region (exclusion region) where the information is to be notified to OS 303, the filter driver notifies the touch information to OS 303, via a human interface device (HID) class driver or an HID driver (not shown). Then, OS 303, in turn, notifies the touch information to application 305.

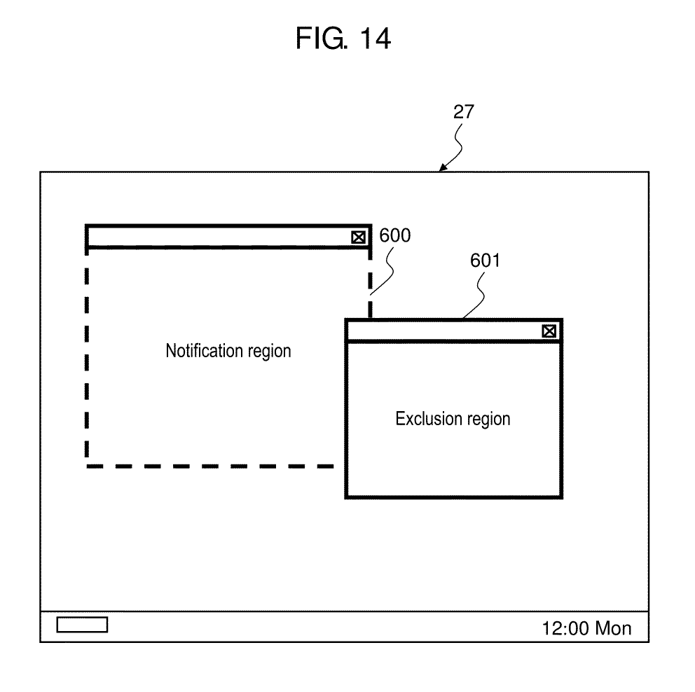

FIG. 14 is a view illustrating the basic function of the display apparatus according to the present disclosure. FIG. 14 shows a multi-window display which is implemented with a graphical user interface (GUI) on the desktop screen of display panel 102. The GUI of display panel 102 has common functions of such a multi-window display as shown in FIG. 14. Therefore, another window sometimes overlaps the window displayed by application 305. In this way, when the configuration of window displays is changed, there occur both a window event indicating such a change in the function of the window display and a window handle to identify individual windows. They occur via either OS 303 or the function of a window manager to control the graphic display. Filter library 307 receives information of the window event and the window handle, which is output from OS 303. Using the thus-received information, the filter library sets a state of the notification region, which reflects the state of the window currently being displayed, in filter driver 302.

Notification region 600 is subjected to the display-control by application 305. The touch information made in notification region 600 is notified directly to application 305. That is, notification region 600 is directly set in filter driver 302 by application 305 via filter library 307. On the other hand, exclusion region 601 is a region which is produced by other applications or OS 303. The touch information made in exclusion region 601 is notified to OS 303. It is noted, however, that other desktop regions except for notification region 600 and exclusion region 601 are also exclusion regions where touch information is notified to OS 303. Filter library 307 detects the state of display of such multi-windows, thereby setting exclusion region 601 other than notification region 600.

Filter library 307 updates and reads region holding information 73. As described later, region holding information 73 contains and updates the touch information detected on a time-series basis, and also contains the region information at the time when the touch information is initially detected.

With this system configuration, notification region 600 and exclusion region 601 are displayed simultaneously on the one display screen via the function of multi-window display. In this case, the following inconvenience may occur.

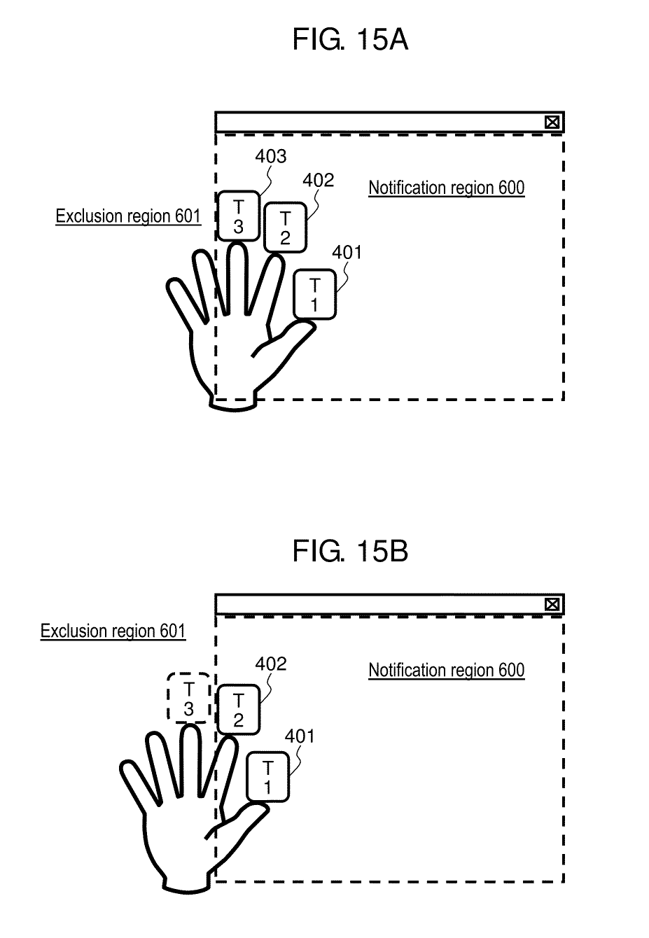

FIGS. 15A and 15B are views of examples of display results. FIGS. 15A and 15B show the cases where notification region 600 is operated on exclusion region 601. FIG. 15A shows the state in which touches T1, T2, and T3 have been consecutively or simultaneously detected in notification region 600, and GUI menus 401 (T1), 402 (T2), and 403 (T3) are displayed via application 305. Here, it is assumed that the user moves the user's hand, so that touch T3 is moved to the outside of notification region 600, that is, moved onto exclusion region 601. In this case, the touch information of touch T3 is notified to OS 303 and then the display based on the touch is controlled by OS 303, resulting in no menu display which would follow the menu display in notification region 600. This harms the continuity of the touch operation that has been started on notification region 600.

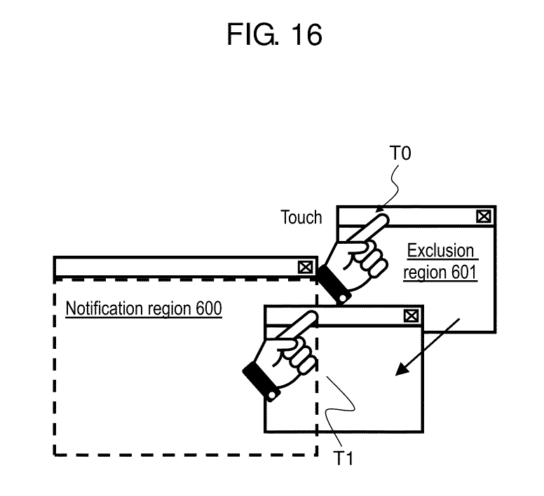

FIG. 16 is a view of an example of a display result. FIG. 16 shows the case where a window of exclusion region 601 is moved via a drag operation (dragging) to pass through over notification region 600. In FIG. 16, the user intends to hold exclusion region 601 via initial touch T0, and then to move the exclusion region over notification region 600. Because touch T0 is positioned in exclusion region 601 (desktop region), the touch information thereof is notified to OS 303. However, when the position of touch T1 is in notification region 600 via the drag operation, the touch information of T1 is not notified to OS 303 and is notified directly to application 305. For this reason, OS 303 determines that the touch is released, and then discontinues the process of moving the window. As a result, the moving of exclusion region 601 via the drag operation is discontinued on notification region 600.

Display apparatus 101 according to the present disclosure has the following configurations and functions so as to ensure continuity of the touch operation on the display screen on which notification region 600 and exclusion region 601 are operated simultaneously.

### First Exemplary Embodiment

A display apparatus according to an embodiment of the present disclosure will be described with reference to FIGS. 1 to 7B.

### [1-1. Configuration]

### [1-1-1. Configuration of Display Apparatus]

### (Display Panel)

FIG. 1 is an external view of display apparatus 101 according to a first embodiment. FIG. 1 shows the external view of display apparatus 101 (an example of a display apparatus) which is a tablet terminal according to the first embodiment.

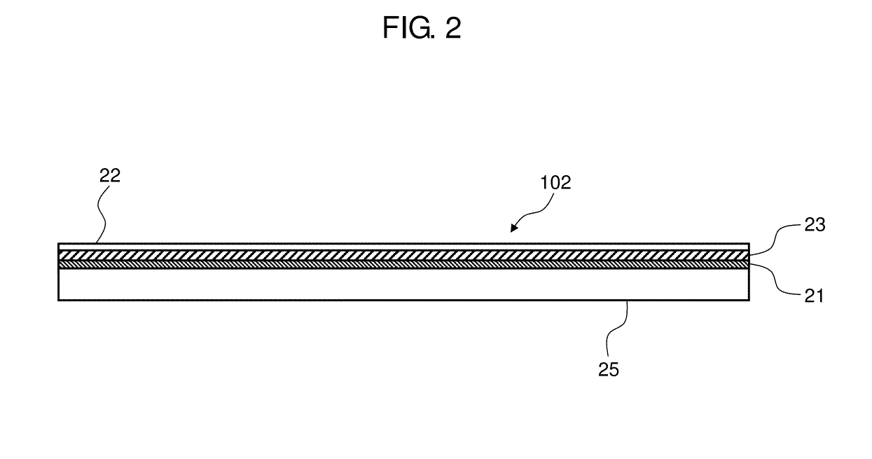

FIG. 2 is a cross-sectional view of display panel 102 according to the first embodiment. FIG. 2 shows a cross section of display panel 102 of display apparatus 101.

As shown in FIGS. 1 and 2, display panel 102 of display apparatus 101 is such that pen panel 21, touch panel 23, and liquid crystal display (LCD) panel 25 are integrally assembled with frame body 24 (FIG. 1) in a laminated state.

Pen panel 21 detects the path of a pen operation by a user, and outputs its original coordinate information to pen-operation detection circuit 31 to be described later.

Touch panel 23 is configured with cover 22 (FIG. 2) composed of an insulating film layer such as a glass or plastic one, an electrode layer, and a substrate layer, in this order from the side on which the user makes operations. The electrode layer is configured such that transparent electrodes are arranged in a matrix with an X-axis (e.g. a lateral axis) and a Y-axis (e.g. a longitudinal axis). It is noted that each of the electrodes may be arranged in a lower density than the density of pixels of LCD panel 25, or in a density approximately equivalent to the density of the pixels. In the embodiment, this description is made for the case where the configuration employs the lower density. Note that touch panel 23 may employ various types of touch panels including an electrostatic-type, resistance film-type, optical-type, ultrasonic-type, and electromagnetic-type ones.

LCD panel 25 provides a display screen to display an image based on image data which are processed by graphic controller 33 (FIG. 3) to be described later. LCD panel 25 displays graphics and text data such as characters and numerals. In the embodiment, LCD panel 25 has a 20-inch diagonal screen with an image resolution of 3,840×560 dots, for example. Note that, other display devices instead of LCD panel 25 may be employed such as an organic electroluminescence (EL) panel, an electronic paper, and a plasma display panel. Moreover, LCD panel 25 may include a power supply circuit and a drive circuit, and may include a light source depending on the type of panel.

Frame body 24 accommodates touch panel 23, pen panel 21, and LCD panel 25. Although omitted in FIG. 1, frame body 24 may be equipped with a power button, a speaker, and the like.

The user performs a touch operation by touching a user's finger to the display screen of display panel 102. Moreover, the user can drive electric pen 105 on the display screen, thereby depicting a drawing. Display panel 102 is suited for producing design drawings such as an architectural blueprint, for example, by using notification region 600 provided by application 305.

### (Internal Configuration)

FIG. 3 is a schematic configuration view of display apparatus 101 according to the first embodiment. FIG. 3 shows the internal configuration of display apparatus 101.

Display apparatus 101 includes display panel 102 described above and controller 103. Controller 103 includes controller 30 (an example of a display controller), pen-operation detection circuit 31, touch-operation detection circuit 32, graphic controller 33, random access memory (RAM) 40, communication circuit 60, and speaker 80.

Pen-operation detection circuit 31 performs a coordinate transformation of the information inputted from pen panel 21, and then outputs the result to controller 30.

Touch-operation detection circuit 32 sequentially scans the matrix, along the X-axis and Y-axis. Upon detecting a variation in electrostatic capacity, touch-operation detection circuit 32 detects that a touch operation is performed at the position where the variation is detected. Then, the touch-operation detection circuit forms coordinate information with a density (resolution) not lower than the density of the pixels of LCD panel 25. Touch-operation detection circuit 32 is capable of simultaneously detecting the touch operations at a plurality of positions, and continuously outputs a series of coordinate data that are detected in accordance with the touch operations. These coordinate data are inputted to controller 30, to be described later, with the coordinate data being detected as various touch operations (such as a tap, drag, flick, and swipe). Note that the tap is an operation of tapping the touch panel lightly with a finger; the drag is an operation of shifting a finger with the finger pushing the touch panel, thereby moving a selected object on the display screen; the flick is an operation of flicking the touch panel lightly with a finger; and the swipe is an operation of sliding a finger with the finger being in contact with the touch panel.

Controller 30 is a processing circuit (e.g. a central processing unit (CPU)) to perform various processes to be described later, by using the detection information detected by pen-operation detection circuit 31 and the touch information detected by touch-operation detection circuit 32. Moreover, controller 30 executes a display control program of application 305, as described later.

Graphic controller 33 operates based on a control signal formed by controller 30. Graphic controller 33 forms the image data to be displayed on LCD panel 25, and controls the display operation of LCD panel 25.

RAM 40 is a so-called work memory. In RAM 40, a display control program to operate display apparatus 101 is developed, with the program being provided by application 305 and executed by controller 30.

Communication circuit 60 is a circuit which allows communications with the Internet and a personal computer, for example. Communication circuit 60 is a wireless communication circuit in accordance with, such as, Wi-Fi or Bluetooth (Registered Trademark) standards, and is capable of communicating with input means such as electronic pen 105 and a mouse.

Speaker 80 outputs sounds in accordance with an audio signal generated by controller 30.

Bus 90 is a signal line which connects constituent elements except for display panel 102, mutually to each other, and allows transmission and reception of signals.

Controller 103 is further connected with storage 70 (an example of a storage unit), as shown in FIG. 3. Storage 70 is a flash memory, for example. Storage 70 stores image data 71 to be used for the display, display control program 72 (application 305) described above, region holding information 73, and the like. In the embodiment, image data 71 include, for example, still image data and three-dimensional image data.

### (Functional Configuration)

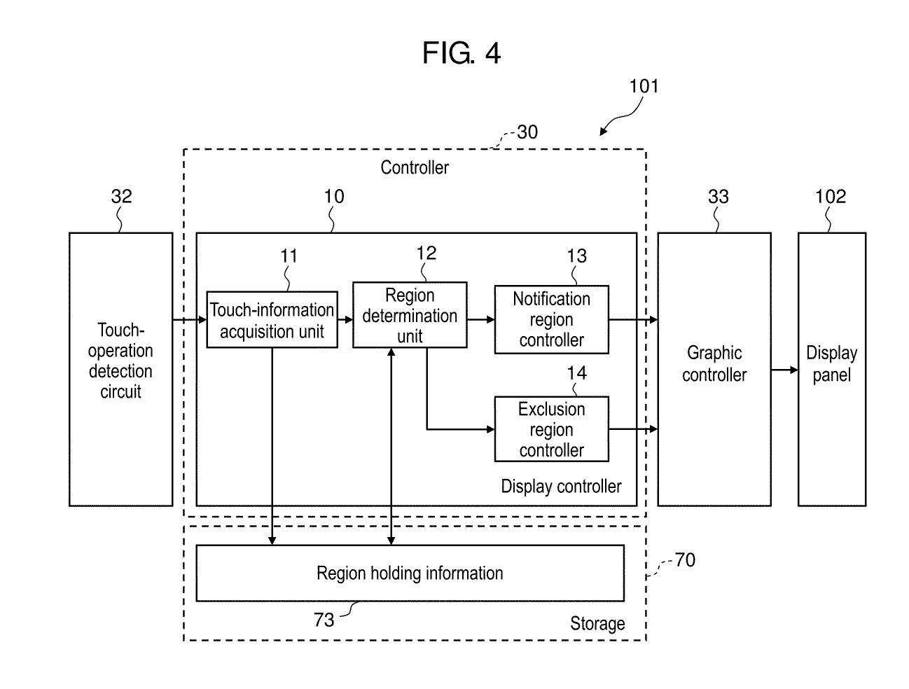

FIG. 4 is a control block diagram of a functional configuration of display apparatus 101. Display apparatus 101 includes display controller 10 (an example of a display controller). Display controller 10 implements functions in such a manner that controller 30 executes display control program 72 developed in a memory such as RAM 40. Display controller 10 includes touch-information acquisition unit 11 (an example of a touch-information acquisition unit), region determination unit 12 (an example of a region determination unit), notification region controller 13 (an example of a second display region controller), and exclusion region controller 14 (an example of a first display region controller).

Touch-information acquisition unit 11 acquires the touch information from touch-operation detection circuit 32 that detects the touch operation performed on display panel 102. The touch information includes positional information that indicates the touch position. Touch-information acquisition unit 11 updates region holding information 73 that is stored in storage 70, in accordance with the thus-acquired touch information, as described later.

Region determination unit 12 determines whether or not the touch is positioned in notification region 600, from the touch information acquired by touch-information acquisition unit 11. When the result of the determination is that the touch is in notification region 600, the region determination unit notifies the touch information directly to application 305 without via OS 303 (FIG. 13). On the other hand, when the result of the determination is that the touch is not in notification region 600, that is, the touch is in exclusion region 601, the region determination unit notifies the touch information to OS 303. Region determination unit 12 updates region holding information 73 in accordance with the result of the determination.

Notification region controller 13 forms a display control command for notification region 600, in accordance with the touch information notified directly to application 305 from region determination unit 12. The thus-formed display control command is transmitted to graphic controller 33. Then, in accordance with the display control command, the window display is performed in notification region 600 on the display screen of display panel 102. Moreover, notification region controller 13 detects an overlap between notification region 600 and exclusion region 601, as described later. Then, the notification region controller sets the overlapping part in a non-notification window (mask window).

Exclusion region controller 14 forms a display control command for exclusion region 601, in accordance with the touch information notified to OS 303 from region determination unit 12. The thus-formed display control command is transmitted to graphic controller 33. Then, in accordance with the display control command, the window display is performed in exclusion region 601 on the display screen of display panel 102.

### [1-2. Operation]

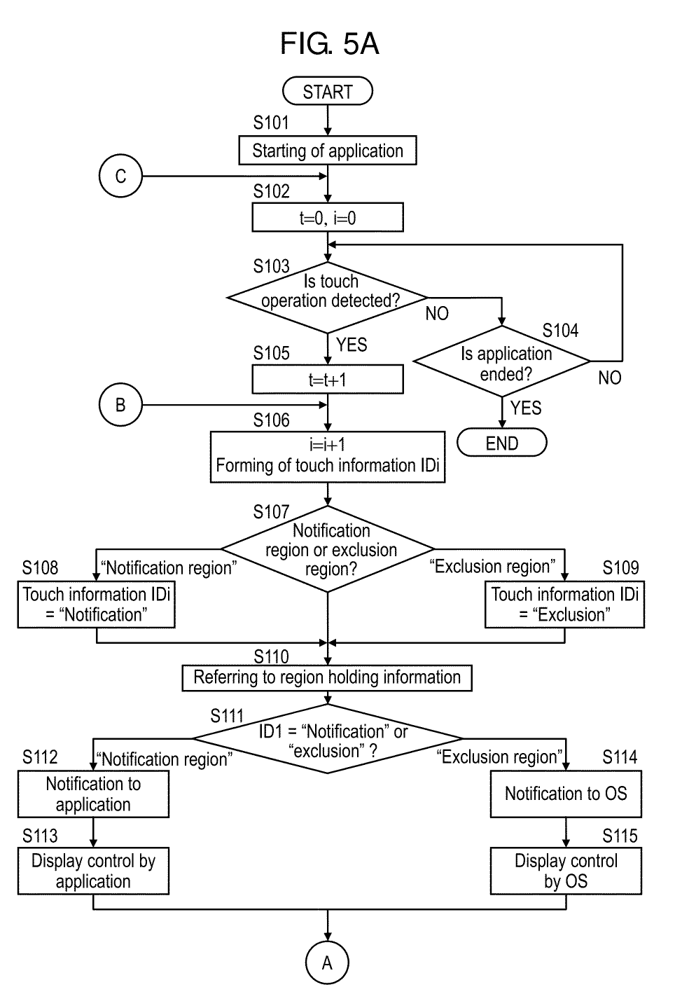

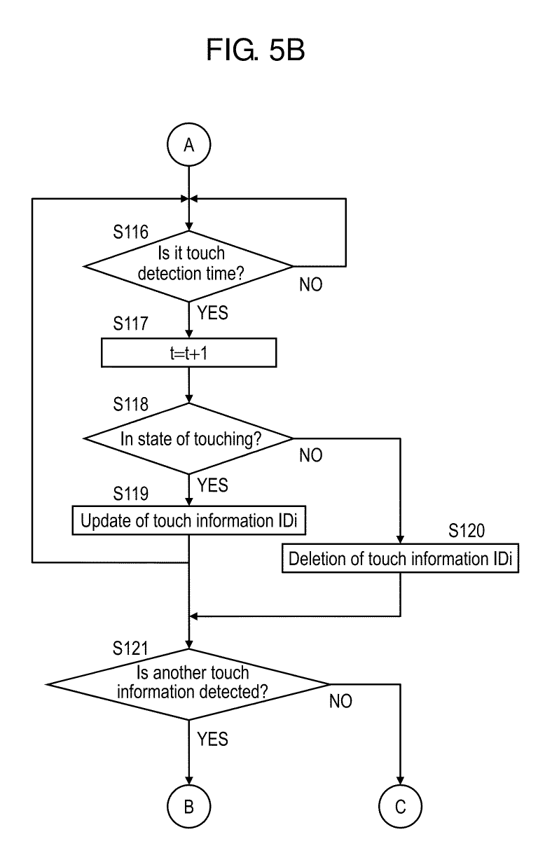

FIGS. 5A and 5B are flowcharts showing a control process that is performed by display apparatus 101 according to the first embodiment.

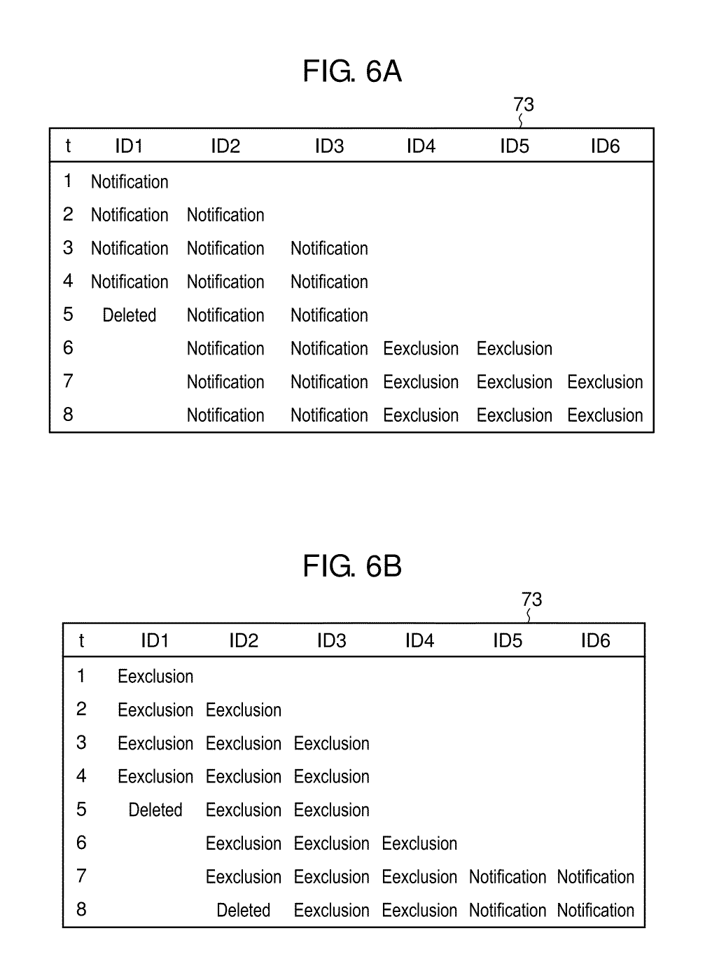

FIGS. 6A and 6B are views showing region holding information that is formed by display apparatus 101 according to the first embodiment.

Referring to FIGS. 5A, 5B, 6A, and 6B, the display control process will be described which is performed by display apparatus 101, mainly by controller 30, according to the embodiment.

S101: Controller 30 starts application 305.

S102: Variables “t” and “i” are initialized. Note that, as described later, variable “t” indicates the point in time when the touch operation is detected. Variable “t” is 0 (zero) during no detection of touch operation. The detection of the touch operation is performed at predetermined time intervals (every 10 ms, for example). Variable “i” indicates the number of the touches that are detected simultaneously or consecutively. Variable “i” is 0 (zero) during no detection of touch operation.

S103: Controller 30 determines whether or not touch-operation detection circuit 32 detects the touch operation. When the touch operation is detected, the process proceeds to Step S105. When the touch operation is not detected, the process proceeds to Step S104.

S104: As long as application 305 is not ended, the process returns to Step S103.

S105: When the touch operation is detected in Step S103, controller 30 increments touch detection time “t.” This indicates that the initial touch operation is detected at the point (t1) in time.

S106: Controller 30 increments touch number “i” and forms touch information IDi. Touch information IDi is information that configures region holding information 73 described above. Touch information IDi includes both information of the presence or absence of touch at touch detection time “t” and information of the region of the touch (that is, regarding whether the region is notification region 600 or exclusion region 601), besides the positional information of the touch on the display screen, as shown in FIGS. 6A and 6B.

S107: Controller 30 determines whether the position at which the touch is detected is in notification region 600 or exclusion region 601. When the result of the determination is that the position is in notification region 600, the process proceeds to Step S108. When the result is that the position is in exclusion region 601, the process proceeds to Step S109.

S108: Controller 30 stores the region of thus-formed touch information IDi as “notification,” as shown in FIG. 6A or 6B.

S109: Controller 30 stores the region of thus-formed touch information IDi as “exclusion,” as shown in FIG. 6A or 6B.

S110: Controller 30 refers to region holding information 73 stored.

S111: Controller 30 determines whether the region of the initial touch information, among the touch information at current touch detection time “t,” is in notification region 600 or exclusion region 601, in region holding information 73.

For example, in the case where the touch information currently detected is the initial information (i.e. touch information ID1 at t=1 in FIG. 6A or 6B), when touch information ID1 indicates notification region 600, the process proceeds to Step S112. When touch information ID1 indicates exclusion region 601, the process proceeds to Step S114. When the touch detections are consecutively made, at the point in time t=5 in FIG. 6A, for example, the touch information latest-detected is ID3, and the initial touch information is ID1. Because touch information ID1 indicates notification region 600, the process proceeds to Step S112. On the other hand, in FIG. 6B, because initial touch information ID1 indicates the exclusion region, the process proceeds to Step S114.

S112: Controller 30 notifies the touch information directly to the application without via OS 303.

S113: Controller 30 controls the display of application 305 via graphic controller 33.

S114: Controller 30 notifies the touch information to OS 303.

S115: Controller 30 controls the display of OS 303 via graphic controller 33.

S116: Controller 30 determines whether or not the time of the next touch detection comes. Then, when it is the time of the next touch detection, the process proceeds to Step S117.

S117: Controller 30 increments touch detection time “t.”

S118: Controller 30 determines the state of touching indicated by current touch information IDi. When the result of the determination is that the state of touching indicated by current touch information IDi is still continued, the process proceeds to Step S119. When the state of touching is not continued, the process proceeds to Step S120.

S119: Controller 30 updates the touch information IDi at incremented touch detection time “t.” In this step, because the state of touching indicated by current touch information IDi is still continued, the information is continuously stored which indicates whether the region is the notification region or the exclusion region. For example, when touch detection time “t” runs from t1 to t2 in FIG. 6A, ID1 at t2 is stored as the notification region because the state of touching indicated by touch information ID1 is still continued. Concerning this ID1, controller 30 updates the touch information every lapse of touch detection time “t” until the state of touching is released (that is, until the touch information is deleted in Step S120).

S120: When the result of the determination is that the state of touching indicated by touch information IDi at incremented touch detection time “t” is not continued, controller 30 deletes touch information IDi (ineffective state). For example, at the point in time t=5 in FIG. 6A or 6B, ID1 is deleted because the state of touching indicated by touch information ID1 has been released.

S121: Controller 30 determines whether or not another touch operation is detected. When another touch operation is detected, the process returns to Step S106 in which new touch information IDi is formed. When no another touch operation is detected, the process returns to Step S102.

### (Result of Operation)

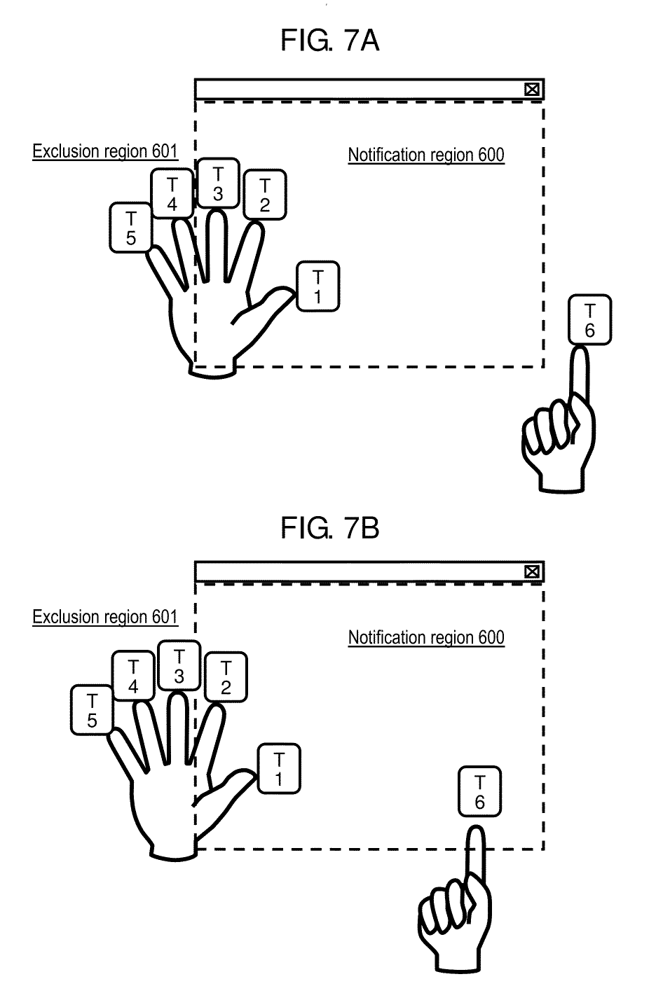

FIGS. 7A and 7B are views illustrating display regions that are output from display apparatus 101 according to the first embodiment. FIGS. 7A and 7B show examples of displays resulted from the processing of display apparatus 101 described above. The examples shown in FIGS. 7A and 7B are each the case where the maximum number of the touching points is six.

In the case shown in FIG. 7A, the positions of touches T1, T2, and T3 are in notification region 600 while the positions of touches T4, T5, and T6 are in exclusion region 601. At the positions of touches T1 to T6, displays (for example, menu displays) are made in accordance with their respective touch operations. In the case shown in FIGS. 15A and 15B, no display that would follow the display in notification region 600 is displayed in exclusion region 601. In contrast, with display apparatus 101 according to the embodiment, in the case where the earliest touch operation (T1, in this case) is performed in notification region 600, the display that follows the display in notification region 600 is continuously displayed in exclusion region 601 even when another subsequent touch operation is performed in exclusion region 601.

In the case shown in FIG. 7B, the positions of touches T1, T2, and T6 are in notification region 600 while the positions of touches T3, T4, and T5 are in exclusion region 601. As in the case shown in FIG. 7A, at the positions of touches T1 to T6, displays are made in accordance with their respective touch operations. Also, the case shown in FIG. 7B is such that: In the case where the earliest touch operation (T1, in this case) is performed in notification region 600, the display that follows the display in notification region 600 is displayed in exclusion region 601 even when another subsequent touch operation is performed in exclusion region 601.

### [1-3. Effects and Others]

Display apparatus 101 according to the embodiment notifies the touch information separately to application 305 and OS 303. In addition, when the touches are consecutively performed, the display apparatus determines whether the initial one of a series of the consecutive touch operations is positioned in notification region 600 or exclusion region 601. Then, for the touch operations subsequent to the initial one, the display apparatus performs the display-control depending on the region of the initial one, with the display-control following the display in the region of the initial one. That is, when the initial one of the series of the consecutive touch operations is positioned in notification region 600, the touch information of the touch operation subsequent to the initial one is notified directly to application 305. Then, the display-control is performed for the region by application 305. In contrast, when the initial one is positioned in exclusion region 601, the touch information of the touch operation subsequent to the initial one is notified to OS 303. Then, the display-control is performed for the region by OS 303.

For this reason, display apparatus 101 according to the embodiment is allowed to concurrently perform the operations, that is, a pointer operation using a pointing device such as electronic pen 105 and a touch operation using the touch panel. That is, display apparatus 101 is capable of providing the window of notification region 600 where the operations by using respective user's hands can be performed. In addition, display apparatus 101 is capable of ensuring the continuity of the touch operation performed between notification region 600 and exclusion region 601.

### Second Exemplary Embodiment

Hereinafter, a display apparatus according to a second embodiment will be described.

### [2-1. Configuration]

The configuration and operations of the display apparatus according to the embodiment are the same as those of display apparatus 101 (FIGS. 1 to 7B and FIG. 13) according to the first embodiment; therefore, the description will be made using the drawings, and reference numerals and symbols thereof, as deemed necessary.

### [2-2. Operation]

Hereinafter, the operation preformed by display apparatus 101 according to the embodiment will be described.

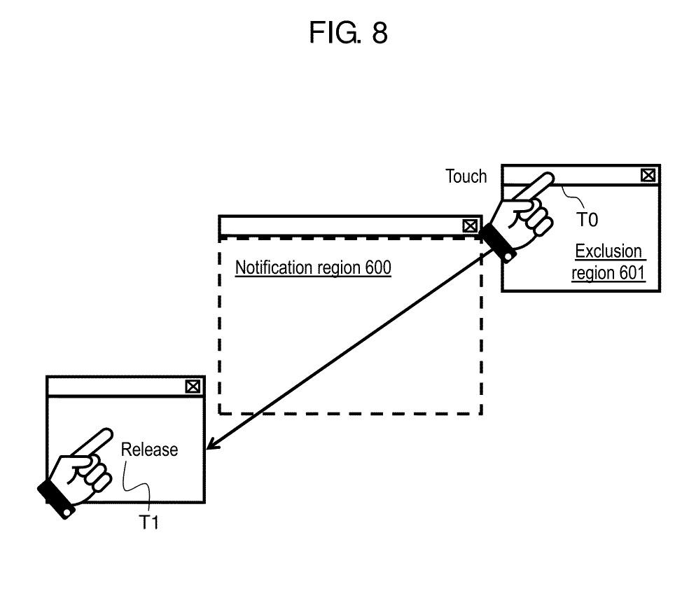

FIG. 8 is a view illustrating an output process that is performed by the display apparatus according to the second embodiment. FIG. 8 shows the exemplary case where, when exclusion region 601 (window) is moved via a drag operation, the exclusion region passes through over notification region 600. In the exemplary case shown in FIG. 8, a user holds exclusion region 601 via the initial touch T0, moves the window to pass through over notification region 600 to the position of touch T1, and then releases the window.

Touch T0 is performed on exclusion region 601. Accordingly, controller 30 notifies the touch information of touch T0 to OS 303 (Steps S107 to S109, in FIG. 5A).

Moreover, T0 is the initial touch information (corresponding to ID1 in FIG. 6B). Accordingly, the information is held in region holding information 73. Controller 30 detects the touch information at any time during the dragging of exclusion region 601, and updates the region holding information (Steps S103 to S121, in FIGS. 5A and 5B).

When exclusion region 601 being held and dragged reaches a position on notification region 600, the touch position enters notification region 600. However, because the touch information of the initial touch T0 indicates exclusion region 601, controller 30 continues to notify the touch information to OS 303 (Step S114 after the determination in Step S110, in FIG. 5A). For this reason, exclusion region 601 being dragged is continuously subjected to the display-control by OS 303, even during the passing through over notification region 600.

As a result, controller 30 is capable of smoothly moving exclusion region 601 to T1 without any interruption of the drag operation.

Note that, when exclusion region 601 is positioned on notification region 600, i.e. exclusion region 601 is displayed to overlap with notification region 600, controller 30 sets thus-overlapping exclusion region 601 to be a mask window (non-notification window). For this reason, exclusion region 601 being moved is determined to be the mask region on the window of notification region 600, and is subjected to the control that follows the touch operation on exclusion region 601.

### [2-3. Effects and Others]

With the configuration and operations described above, in display apparatus 101 according to the embodiment, OS 303 can acquire the touch information of the touch operation performed even on notification region 600, by regarding the touch operation performed on the notification region as that performed on exclusion region 601. For this reason, with the window control by OS 303, the user can move exclusion region 601 from the position of T0 to the position of T1 on the display screen, without any interruption.

### Third Exemplary Embodiment

Hereinafter, a display apparatus according to a third embodiment will be described.

### [3-1. Configuration]

The configuration and operations of the display apparatus according to the embodiment are the same as those of display apparatus 101 (FIGS. 1 to 7B and FIG. 13) according to the first embodiment; therefore, the description will be made using the drawings, and reference numerals and symbols thereof, as deemed necessary.

### [3-2. Operation]

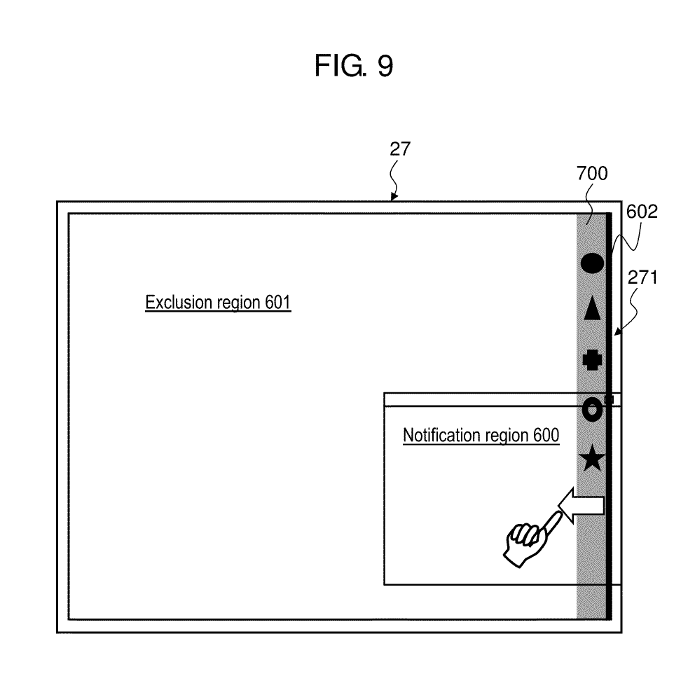

FIG. 9 is a view illustrating an output process that is performed by the display apparatus according to the third embodiment. FIG. 9 shows the exemplary case where charm bar 700 is displayed when notification region 600 is in operation on exclusion region 601 (i.e. the desk top region, in this case) of display screen 27.

Charm bar 700 is a window controlled by OS 303, which displays a menu for setting of the display on the display screen. Charm bar 700 is displayed in such a manner that, for example, a user performs a swipe operation inward from periphery 271 of display screen 27 with a user's finger to pull out the charm bar from periphery 271. Note that, FIG. 9 shows the case where the swipe operation is performed from the rightmost side of the display screen to display charm bar 700 there. However, the position from which the swipe operation is performed to display charm bar 700 may be at any of a left, top, and bottom sides of the screen.

In such a display screen capable of displaying charm bar 700, for example, it is assumed here that notification region 600 comes to overlap with the rightmost portion of display screen 27, as shown in FIG. 9. In this case, even when a swipe operation is performed on notification region 600, the touch information of the operation is not notified to OS 303. Therefore, OS 303 cannot detect the touch information, which prevents charm bar 700 from being pulled out and displayed.

To address such a problem, in display apparatus 101 of the embodiment, controller 30 sets a mask window (non-notification region) along periphery 271 of display screen 27. It is noted, however, that the mask window may be in a range of a few-pixels distance inwardly from periphery 271.

When the user performs the swipe operation inward from periphery 271 of display screen 27 with a user's finger so as to display charm bar 700, the user initially touches the finger to exclusion region (mask window) 602 arranged at periphery 271 of display screen 27. Accordingly, the touch information of the initial touch is acquired as that of exclusion region 601. Even when the touch operation attributed to the swipe operation runs later into notification region 600, the consecutive touch information attributed to the swipe operation is notified to OS 303 because the initial touch has been performed in exclusion region 602 (Steps S103 to S114, in FIG. 5A). Therefore, the user can display and operate charm bar 700 controlled by OS 303. Moreover, as for the overlap portion between charm bar 700 and notification region 600, controller 30 sets the portion as a mask window, allowing the display of charm bar 700 without problems.

### Modified Example

Instead of the mask window that is set along periphery 271 of display screen 27 as described above, it is possible to perform the display-control as follows.

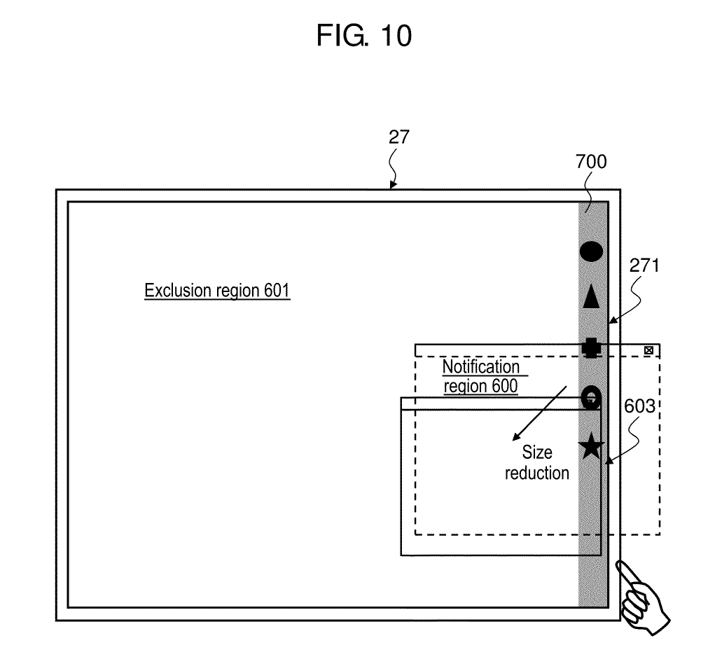

FIG. 10 is a view illustrating an output process that is performed by a display apparatus according to a modified example of the third embodiment. When the window of notification region 600 comes to overlap with periphery 271 of display screen 27, controller 30 automatically reduces the size of the window of notification region 600. The size reduction is made to show the extent to which exclusion region 603 can be ensured between the right side periphery of notification region 600 and periphery 271 of display screen 27. Accordingly, the initial touch of the touch operation attributed to the user's swipe operation from periphery 271 of display screen 27 is performed in exclusion region 603 (Steps S103 to S114, in FIG. 5A). Then, the touch information attributed to the swipe operation is notified to OS 303. Therefore, the user can display and operate charm bar 700 controlled by OS 303.

### [3-3. Effects and Others]

With the configurations and operations, display apparatus 101 according to the embodiment is capable of ensuring the mask region at periphery 271 of the display screen. This allows the simultaneous displays of notification region 600 and charm bar 700. Moreover, notification region 600 has no influence on the operation of charm bar 700.

### Other Exemplary Embodiments

As described above, the first to third embodiments have been described to exemplify the technology disclosed in the present application. However, the technology according to the present disclosure is not limited to these embodiments, and is also applicable to the embodiments that are subjected, as appropriate, to various changes and modifications, replacements, additions, omissions, and the like. Moreover, the technology disclosed herein also allows other embodiments which are each configured by combining the appropriate constituent elements and functions that have been described in the first to third embodiments.

Now, such embodiments will be described as exemplifications, hereinafter.

[1]

The first to third embodiments have been described above using the example in which display apparatus 101 is the tablet terminal that is configured integrally with display panel 102 and controller 103. However, the display apparatus is not limited to this. The display apparatus may be configured such that a part of controller 103 is mounted on a computer terminal, i.e. another apparatus, with the terminal being connected to display panel 102.

[2]

The order in which the steps (FIGS. 5A, 5B, etc.) according to the first to third embodiments described above are performed, is not limited to the descriptions of these embodiments described above. The order of these steps may be changed without departing from the gist of the present disclosure.

[3]

The present disclosure is not limited to the mode implemented by display apparatus 101. Other modes also fall within the scope of the present disclosure, which are implemented by the method of controlling the display performed by display apparatus 101, the computer program executed by display apparatus 101, and a computer-readable record medium to store the program. Here, the computer-readable record medium includes, for example, a flexible disk, hard disk, CD-ROM, MO, DVD, DVD-ROM, DVD-RAM, BD (Blu-ray (Registered Trademark) Disc), and semiconductor memory.

The computer program described above is not limited to one stored in the record medium described above. Instead, the computer program may be one which is transmitted via an electric communication line, wired or wireless communication line, network most notably the Internet, or the like.

It is noted that, in the present disclosure, display apparatus 101 is an example of the display apparatus. Electronic pen 105 is an example of the pointing device. Display controller 10 is an example of the display controller. Controller 30 is an example of the display controller. Notification region 600 is an example of the second display region. Exclusion region 601 is an example of the first display region. Exclusion region 602 is an example of the first display region. Exclusion region 603 is an example of the first display region. Charm bar 700 is an example of the first display region. Storage 70 is an example of the storage unit. Touch-information acquisition unit 11 is an example of the touch-information acquisition unit. Region determination unit 12 is an example of the region determination unit. Notification region controller 13 is an example of the second display region controller. Exclusion region controller 14 is an example of the first display region controller.

The technology according to the present disclosure is usable for display apparatuses, such as tablet terminals employing pointing devices.

What is claimed is:

1. A display apparatus having a touch panel, comprising:
a display screen capable of displaying information in accordance with a touch operation;
a first display region displayed on the display screen, for displaying the information in accordance with touch information acquired by an operating system (OS);
a second display region displayed on the display screen along with the first display region, for displaying the information in accordance with the touch information acquired by a predetermined application without via the OS; and
a display controller for performing a display of the first display region on the display screen and a display of the second display region on the display screen, in accordance with the touch operation,
wherein, when the first display region on the display screen is moved by dragging over the second display region, the display controller moves the first display region in accordance with the touch information acquired by the OS.

2. The display apparatus according to claim 1, wherein the touch information includes at least both information indicating a touch position on the display screen and information indicating whether the touch position is in the first display region or the second display region.

3. The display apparatus according to claim 1, further comprising a storage unit, wherein the display controller stores the touch information into the storage unit, and updates the touch information at predetermined time intervals.

4. The display apparatus according to claim 1,
wherein the display controller performs a display following the display of the first display region when the touch operation is performed continuously from the first display region to the second display region, and
the display controller performs a display following the display of the second display region when the touch operation is performed continuously from the second display region to the first display region.

5. The display apparatus according to claim 1, wherein the second display region is capable of simultaneously displaying both the information in accordance with the touch operation by a pointing device and the information in accordance with the touch operation by a hand.

6. A display apparatus having a touch panel, comprising:
a display screen capable of displaying information in accordance with a touch operation;
a touch-information acquisition unit for acquiring touch information on the display screen;
a first display region displayed on the display screen;
a second display region displayed on the display screen along with the first display region;
a region determination unit for determining whether a touch position is in the first display region or the second display region, based on the touch information;
a first display region controller for performing a display of the first display region in accordance with the touch information notified from the region determination unit to an operating system (OS); and
a second display region controller for performing a display of the second display region in accordance with the touch information notified from the region determination unit to a predetermined application without via the OS,
wherein, when the touch-information acquisition unit consecutively acquires the touch information, and yet when an initial touch position is in the first display region, even if, among the consecutively-acquired touch information, at least one of the touch positions following the initial touch position is in the second display region, the first display region controller performs the display on the second display region.

7. A display apparatus according to claim 6, wherein when the initial touch position is in the second display region, even if, among the consecutively-acquired touch information, at least one of the touch positions following the initial touch position is in the first display region, the second display region controller performs the display on the first display region.

8. A method of controlling a display on a display panel capable of displaying information in accordance with a touch operation, the method comprising the steps of;
displaying a first display region on a display screen of the display panel, the first display region being capable of displaying the information in accordance with touch information acquired by an operating system (OS);
displaying a second display region on the display screen along with the first display region, the second display region being capable of displaying the information in accordance with the touch information acquired by a predetermined application without via the OS; and
moving the first display region in accordance with the touch information acquired by the OS when the first display region on the display screen is moved by dragging over the second display region.
